(19) United States
(12) Patent Application Publication
(10) Pub. No.: US 2011/0122102 A1
(43) Pub. Date: May 26, 2011

(54) Driving Circuit and Output Buffer

(75) Inventors: Ko-Yang Tso, Jhonghe City (TW); Hui-Wen Miao, Hsinchu City (TW); Yu-Lung Lo, Banqiao City (TW); Yann-Hsiung Liang, Hsinchu City (TW); Hsin-Yeh Wu, Kaohsiung City (TW)

(73) Assignee: RAYDIUM SEMICONDUCTOR CORPORATION, Hsinchu (TW)

(21) Appl. No.: 12/900,236

(22) Filed: Oct. 7, 2010

(30) Foreign Application Priority Data
Nov. 26, 2009 (TW) 98140419

(51) Int. Cl. G06F 3/038

(52) U.S. Cl. 345/204; 345/87

(57) ABSTRACT

An output buffer including a first switch circuit and a buffer is provided. The first switch circuit receives first and second input signals. The buffer circuit includes first and second input stages, first and second output stages and a second switch circuit. The first and the second input stages are coupled to the first switch circuit. The first and the second output stages are coupled to the second switch circuit. The second switch circuit, coupled to the first and the second input stages and the first and the second output stages, selectively couples one of first and the second input stages to the first output stage and selectively couples the other to the second output stage. The first switch circuit further selectively provides one of the first and the second input signals to the first input stage and selectively provides the other to the second input stage.

This application claims the benefit of Taiwan application Serial No. 098140419, filed Nov. 26, 2009, the subject matter of which is incorporated herein by reference.

### BACKGROUND OF THE INVENTION

1. Field of the Invention

The invention relates in general to a driver, and more particularly to a driver used in electronic display device.

2. Description of the Related Art

Liquid crystal display (LCD) having the advantages of low radiation and low power consumption, has become the mainstream display product. The LCD normally includes a number of source drivers, which provides an analog driving voltage to drive the LCD panel. Conventionally, a source driver would employ two sets of output buffers to provide positive and negative output voltages. Thus, in response to each output channel, the source driver can, in different frame periods, provide analog driving voltages with a non-inverted polarity or that with an inverted polarity to the LCD panel. However, the threshold voltages of the positive and the negative output buffers may not match with each other due to process factors. When mismatching of the threshold voltages occurs, the positive and the negative analog driving voltages outputted by the conventional source driver will not match with each other either, and the occurrence of abnormal display will occur.

### SUMMARY OF THE INVENTION

The invention is directed to an output buffer used for driving first and second output channels, wherein the output buffer includes first and second input stages. The output buffer directed to by the invention switches the transmission path of the input and the output signals of the first and the second input stages with a switch circuit, so that the signals generated and amplified by the first and the second input stages are constantly used as the output signals of the first and the second output channels respectively. In other words, the output buffer directed to by the invention can drive the fixed output channels with fixed input stages. In comparison to the conventional output buffer, the output buffer directed to by the invention effectively avoids the mismatching between the positive and the negative analog driving voltages outputted by the conventional source driver, which occurs due to the mismatching between the threshold voltages of the buffers, hence avoiding the occurrence of abnormal display. Thus, the outputted positive and negative analog driving voltages match with each other and the display effect is improved.

According to a first aspect of the present invention, an output buffer used in driver is provided. The output buffer includes a first switch circuit and a buffer circuit. The first switch circuit receives first and second input signals. The buffer circuit includes first and second input stages, first and second output stages and a second switch circuit. The first and the second input stages are coupled to the first switch circuit. The first and the second output stages are coupled to the second switch circuit. The second switch circuit, coupled to the first and the second input stages and the first and the second output stages, selectively couples one of the first and the second input stages to the first output stage and selectively couples the other of the first and the second input stages to the second output stage. The first switch circuit further selectively provides one of the first and the second input signals to the first input stage and selectively provides the other of the first and the second input signals to the second input stage.

According to a second aspect of the present invention, a driver used in electronic display device is provided. The driver includes first and second conversion circuits and an output buffer. The first and the second conversion circuits respectively provide first and second input signals. The output buffer includes a first switch circuit and the buffer circuit. The first switch circuit receives the first and the second input signals. The buffer circuit includes first and second input stages, first and second output stages and a second switch circuit. The first and the second input stages are coupled to the first switch circuit. The first and the second output stages are coupled to the second switch circuit. The second switch circuit, coupled to the first and the second input stages and the first and the second output stages, selectively couples one of the first and the second input stages to the first output stage and selectively couples the other of the first and the second input stages to the second output stage. The first switch circuit further selectively provides one of the first and the second input signals to the first input stage and selectively provides the other of the first and the second input signals to the second input stage.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a driver according to an embodiment of the invention;

FIG. 2 shows a detailed circuit diagram of the switch circuit SW1 of FIG. 1;

FIG. 3 shows a detailed circuit diagram of the switch circuit SW2 of FIG. 1;

FIG. 4 shows a detailed circuit diagram of the switch circuit SW3 of FIG. 1;

FIG. 5 shows a relevant signal timing diagram of the driver 1 of FIG. 1;

FIG. 6 A shows an equivalent block diagram when the output buffer 10 of FIG. 1 is in a first polarity operational state; and

FIG. 6 B shows an equivalent block diagram when the output buffer 10 of FIG. 1 is in a second polarity operational state.

### DETAILED DESCRIPTION OF THE INVENTION

The driver of an embodiment of the invention switches the transmission path of the input and the output signals of the first and the second input stages with a switch circuit, so that the signals generated and amplified by the first and the second input stages are constantly used as the output signals of the first and the second output channels respectively.

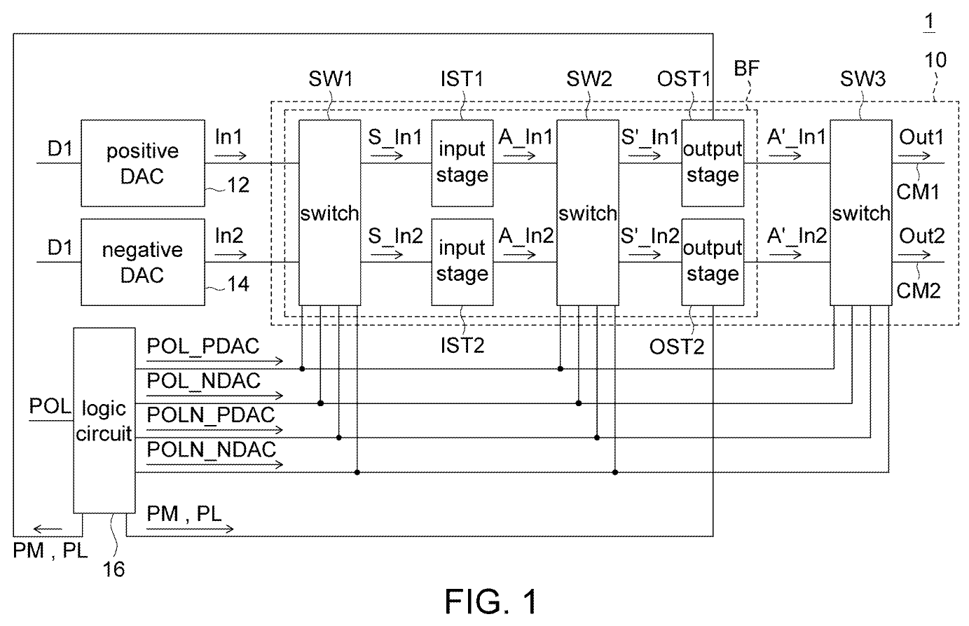

Referring to FIG. 1, a block diagram of a driver according to an embodiment of the invention is shown. The driver 1 is used in electronic display device such as LCD. In an implementation, the driver 1 is realized by a source driver having a number of output channels for driving a number of pixel columns of the LCD. Only a partial structure of the source driver is illustrated in FIG. 1.

The driver 1 includes an output buffer 10, and first and second conversion circuits. The first and the second conversion circuits, such as digital analog converter (DAC), respectively provide analog input signals In1 and In2 in response to input digital signals D1 and D2. For example, the first conversion circuit, which is a positive DAC (PDAC) 12 realized by a P-type transistor, provides a positive analog voltage, which has positive polarity in comparison to the common voltage of an electronic display device. The second conversion circuit, which is a negative DAC (NDAC) 14 realized by an N-type transistor, provides a negative analog voltage, which has negative polarity in comparison to the common voltage of an electronic display device.

The electronic display device using the driver 1 of an embodiment of the invention further includes a timing controller (not illustrated), which provides a polarity inversion control signal POL to the driver 1. For example, the driver 1 includes a logic circuit 16, which performs logic computation on the polarity inversion control signal POL to generate the control signals POL_PDAC, POL_NDAC, POLN_PDAC and POLN_NDAC. The control signals POL_PDAC, POL_NDAC, POLN_PDAC and POLN_NDAC control the output buffer 10 to selectively output positive and negative analog voltages for driving the electronic display device in an alternate polarity inversion manner.

The output buffer 10 includes switch circuits SW1, SW3, a buffer circuit BF and output channels CH1 and CH2. The buffer circuit BF includes input stages IST1 and IST2, output stages OST1 and OST2, and a switch circuit SW2. The switch circuit SW1 is coupled to the PDAC 12 and the NDAC 14, and the input stages IST1 and IST2. The switch circuit SW2 is coupled to the input stage IST1 and IST2 and the output stages OST1 and OST2. The switch circuit SW3 is coupled to the output stages OST1 and OST2 and the output channels CH1 and CH2.

The switch circuit SW1 receives the analog input signals In1 and In2, and is controlled by the control signals POL_PDAC, POL_NDAC, POLN_PDAC and POLN_NDAC to couple one of the PDAC 12 and the NDAC 14 to the input stage IST1 and couple the other of the PDAC 12 and the NDAC 14 to the input stage IST2, so that one of the analog input signal In1 and In2 is used as a switch signal S_In1 provided to the input stage IST1, and the other of the analog input signal In1 and In2 is used as a switch signal S_In2 provided to the input stage IST2.

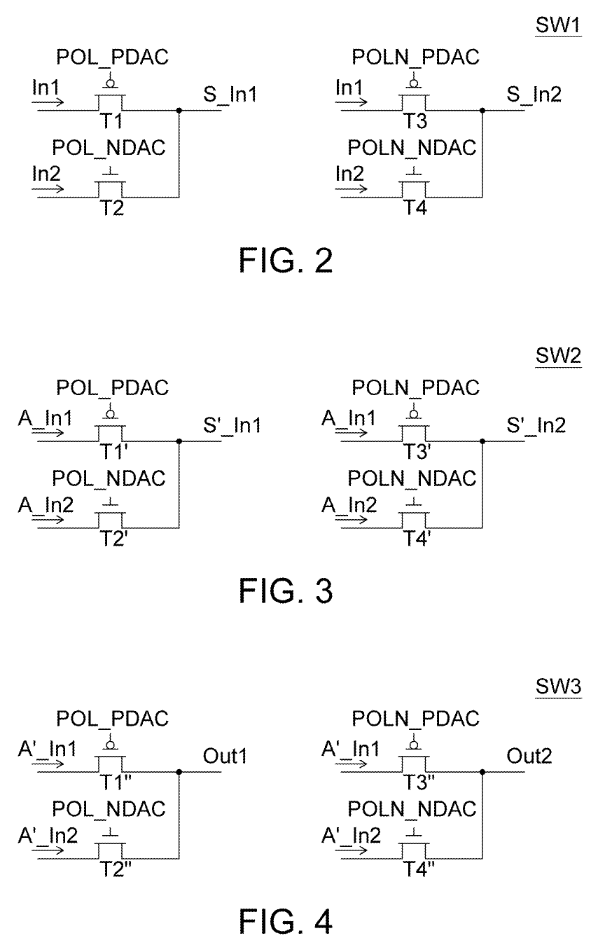

Referring to FIG. 2, a detailed circuit diagram of the switch circuit SW1 of FIG. 1 is shown. For example, the switch circuit SW1 includes transistors T1-T4, wherein the transistors T1 and T3 are P-type metal oxide (PMOS) transistors are turned off in response to high signal levels of the control signals POL_PDAC and POLN_PDAC. The transistors T1 and T3 are further turned on in response to low signal levels of the control signals POL_PDAC and POLN_PDAC. The analog input signal In1 is used as a switch signal S_In1 provided to the input stage IST1, and the analog input signal In1 is used as a switch signal S_In2 provided to the input stage IST2.

The transistor T2 and T4 are N-type metal oxide (NMOS) transistors are turned off in response to low signal levels of the control signals POL_NDAC and POLN_NDAC. The transistor T2 and T4 are further turned on in response to high signal levels of the control signals POL_NDAC and POLN_NDAC. The analog input signal In2 is used as a switch signal S_In1 provided to the input stage IST1, and the analog input signal In2 is used as a switch signal S_In2 provided to the input stage IST2.

The input stages IST1 and IST2, which can be realized by the input stage circuit of a computing amplifier, carry out the main gain amplifying operation of the switch signals S_In1 and S_In2 to generate amplified signals A_In1 and A_In2.

Referring to FIG. 3, a detailed circuit diagram of the switch circuit SW2 of FIG. 1 is shown. The switch circuit SW2 receives the amplified signals A_In1 and A_In2, and is controlled by the control signals POL_PDAC, POL_NDAC, POLN_PDAC and POLN_NDAC to couple one of input stage IST1 and IST2 to the output stages OST1 and couple the other of the input stage IST1 and IST2 to the output stages OST2. Thus, one of the amplified signals A_In1 and A_In2 is used as a switch signal S′_In1 provided to the output stages OST1, and the other of the amplified signals A_In1 and A_In2 is used as a switch signal S′_In2 provided to the output stages OST2. For example, the switch circuit SW2 and SW1 substantially have the same circuit structure and circuit operation. The switch circuit SW2 includes transistors T1′-T4′ whose operations are similar to that of the transistor T1-T4, and the similarities are not repeated here.

The output stages OST1 and OST2, which can be realized by the output stage circuit of a computing amplifier, amplify the switch signals S′_In1 and S′_In2 to generate amplified signals A′_In1 and A′_In2.

Referring to FIG. 4, a detailed circuit diagram of the switch circuit SW3 of FIG. 1 is shown. The switch circuit SW3 receives the amplified signals A′_In1 and A′_In2, and is controlled by the control signals POL_PDAC, POL_NDAC, POLN_PDAC and POLN_NDAC to couples one of the output stages OST1 and OST2 to the output channel CH1 and couple the other of the output stages OST1 and OST2 to the output channel CH2, so that one of the amplified signals A′_In1 and A′_In2 is used as an output signals Out1 provided to the output channel CH1, and the other of the amplified signals A′_In1 and A′_In2 is used as an output signal Out2 provided to the output channel CH2.

For example, the switch circuits SW3 has substantially the same circuit structure as the switch circuits SW1 and SW2. The switch circuit SW3 includes transistors T1″-T4″ whose operations are similar to that of the transistors T1-T4 and T1′-T4′, and the similarities are not repeated here.

The output channels CH1 and CH2 respectively receive the output signals Out1 and Out2, and accordingly drive the corresponding pixel columns. For example, the output channels CH1 and CH2 correspond to the pixels of the (2i+1)-th and the (2i+2)-th columns of the display panel in an electronic display device, wherein i is an integer larger or equal to 0. Let i be equal to 0, then the output channels CH1 and CH2 respectively correspond to the pixels of the first and the second columns of the display panel, and provide an analog voltage signal to respectively drive the pixels of the first and the second columns.

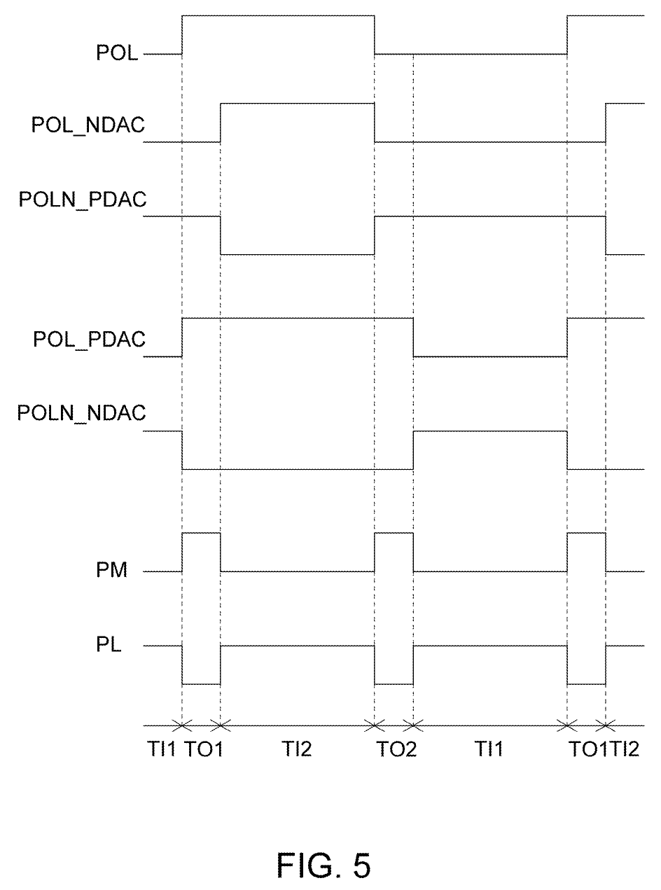

Referring to FIG. 5, a relevant signal timing diagram of the driver 1 of FIG. 1 is shown. The output buffer 10, controlled by polarity inversion control signals POL, is in a first polarity operational state during an operational period TI1 and in a second polarity operational state during an operational period TI2. For example, in the first polarity operational state, the signals of the output channels CH1 and CH2 correspond to positive polarity and negative polarity respectively; in the second polarity operational state, the signals of the output channels CH1 and CH2 correspond to negative polarity and positive polarity respectively.

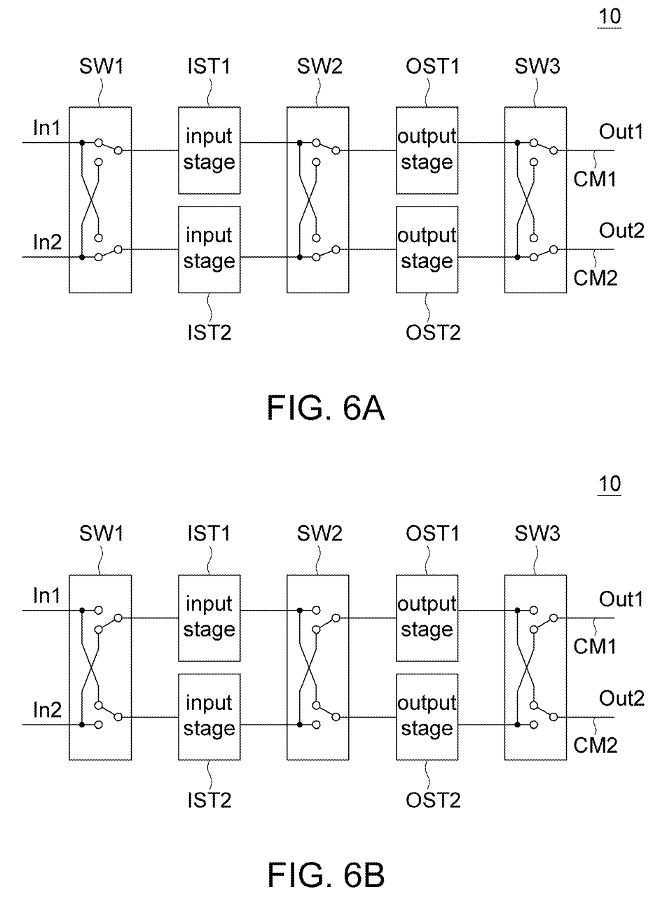

Furthermore, during the operational period TI1, the polarity inversion control signal POL and the control signals POL_NDAC and POL_PDAC have low signal levels, and the control signals POLN_PDAC and POLN_NDAC have high signal levels. Thus, the transistors T2, T2′, T2″, T3, T3′ and T3″ are turned off, and the transistors T1, T1′, T1″, T4, T4′ and T4″ are turned on, so that the output buffer 10, having an equivalent block diagram as indicated in FIG. 6 A, provides a positive output signal Out1 to the output channel CH1 according to the positive input analog signal In1 and provides a negative output signal Out2 to the output channels CH2 according to the negative input analog signal In2.

During the operational period TI2, the polarity inversion control signal POL and the control signals POL_NDAC and POL_PDAC have high signal levels, and the control signals POLN_PDAC and POLN_NDAC have low signal levels. Thus, the transistors T1, T1′, T1″, T4, T4′ and T4″ are turned off, and the transistors T2, T2′, T2″, T3, T3′ and T3″ are turned on, so that the output buffer 10, having an equivalent block diagram as indicated in FIG. 6 B, provides a positive output signal Out2 to the output channel CH2 according to the positive input analog signal In1 and provides a negative output signal Out1 to the output channel CH1 according to the negative input analog signal In2.

In an example, there are switch periods TO1 and TO2 existing between the operational period TI1 and TI2. During the switch periods TO1 and TO2, the control signals POL_PDAC and POLN_PDAC have high signal levels, and the control signals POL_NDAC and POLN_NDAC have low signal levels. Thus, the transistors T1-T4, T1′-T4′ and T1″-T4″ are all turned off, so that the input and the output nodes of the input stages IST1 and IST2 and the output stages OST1 and OST2 are all floating to avoid malfunction, which occurs when the switch circuits SW1-SW3 respond to the control signals POL_PDAC, POL_NDAC, POLN_PDAC and POLN_NDAC whose level transition time lasting for too long.

In an example, the logic circuit 16 further provides bias voltages signals PH and PL to the output stages OST1 and OST2. The bias voltage signals PH and PL, enabled between the switch periods TO1 and TO2, provide the reference bias voltages having a high signal level VDD and a low signal level VSS to the output stages OST1 and OST2 respectively when the input and the output nodes of the output stages OST1 and OST2 are floating to assure that the output stages OST1 and OST2 are operated with ideal operating bias voltages.

In an embodiment, the input stages IST1 and IST2 need to amplify the positive switch signal S_In1 and the negative switch signal S_In2. Thus, the input stages IST1 and IST2 need to be driven by a rail-to-rail supply signal. That is, the high voltage signal and the low voltage signal of the supply signals of the input stage IST1 and IST2 need to be equal to the highest voltage signal VDD and the lowest voltage signal VSS of the output signals Out1 and Out2 respectively.

In an embodiment, the output stage OST1 only amplifies the positive switch signal S′_In1 and the output stage OST2 only amplifies negative the switch signal S′_In2. Thus, the output stages OST1 and OST2 can be driven by a half supply signal. That is, the high voltage signal and the low voltage signal of the supply signal of the output stage OST1 only need to be equal to the highest voltage signal VDD and half voltage signal VDD/2 of the output signals Out1 and Out2 respectively, and the high voltage signal and the low voltage signal of the supply signal of the output stages OST2 only need to be equal to the half voltage signal VDD/2 and the lowest voltage signal VSS of the output signals Out1 and Out2 respectively.

The output buffer of the above embodiment of embodiment includes first and second input stages for carrying out the main gain amplifying operation. The relevant output buffer of the invention switches the transmission path of the input and the output signals of the first and the second input stages with a switch circuit, so that the signals generated and amplified by the first and the second input stages are constantly used as the output signals of the first and the second output channels respectively. In other words, the relevant output buffer of the invention can drive the fixed output channels with fixed input stages. In comparison to the conventional output buffer, the relevant output buffer of the invention effectively avoids the mismatching between the positive and the negative analog driving voltages outputted by the conventional source driver, which occurs due to the mismatching between the threshold voltages of the buffers, hence avoiding the occurrence of abnormal display. Thus, the outputted positive and negative analog driving voltages match with each other and the display effect is improved.

The output buffer of the above embodiments of the invention further includes first and second output stages, and drives the first and the second output stages with a half supply signal. Thus, the output buffer of the embodiments of the invention further has the advantage of low power consumption.

The output buffer of the above embodiments of the invention further performs timing control to the polarity inversion of the output buffer with four control signals. A switch period is disposed between the first and the second operational periods (in which an output signal with the first polarity and an output signal with the second polarity are respectively provided) of the output buffer to assure that the first and the second operational periods are not overlapped, hence avoiding malfunction which occurs due to the first to the third switch circuits of the output buffer.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An output buffer, used in a driver, wherein the output buffer comprises:
a first switch circuit for receiving a first input signal and a second input signal; and
a buffer circuit, comprising:
a first input stage and a second input stage both coupled to the first switch circuit;
a first output stages and a second output stages both coupled to the second switch circuit; and
a second switch circuit coupled to the first and the second input stage and coupled to the first and the second output stages, wherein the second switch circuit selectively couples one of the first and the second input stages to the first output stage and selectively couples the other of the first and the second input stages to the second output stage; and
wherein, the first switch circuit further selectively provides one of the first and the second input signals to the first input stage and selectively provides the other of the first and the second input signals to the second input stage.

2. The output buffer according to claim 1, further comprising:
a first output channel and a second output channel; and
a third switch circuit coupled to the first and the second output stages, and coupled to the first and the second output channels, wherein the third switch circuit selectively couples one of the first and the second output stages to the first output channel and selectively couples the other of the first and the second output stages to the second output channel.

3. The output buffer according to claim 2, wherein, in a first operational mode:
the first switch circuit provides the first input signal to the first input stage;
the first switch circuit provides the second input signal to the second input stage;
the second switch circuit couples the first input stage to the first output stage;
the second switch circuit couples the second input stage to the second output stage;
the third switch circuit couples the first output stage to the first output channel; and
the third switch circuit couples the second output stages to the second output channel.

4. The output buffer according to claim 2, wherein, in a second operational mode:
the first switch circuit provides the first input signal to the second input stage;
the first switch circuit provides the second input signal to the first input stage;
the second switch circuit couples the first input stage to the second output stage;
the second switch circuit couples the second input stage to the first output stage;
the third switch circuit couples the first output stage to the second output channel; and
the third switch circuit couples the second output stages to the first output channel.

5. The output buffer according to claim 4, wherein the first and the second operational mode are respectively operated in a first operational period and a second operational period, and the first and the second operational period are not overlapped.

6. A driver used in an electronic display device, wherein the driver comprises:
a first conversion circuit and a second conversion circuit for providing a first input signal and a second input signal respectively; and
an output buffer, comprising:
a first switch circuit for receiving the first and the second input signals; and
a buffer circuit, comprising:
a first input stage and a second input stage both coupled to the first switch circuit;
a first output stages and a second output stages both coupled to the second switch circuit; and
a second switch circuit both coupled to the first and the second input stage, and coupled to the first and the second output stages, wherein the second switch circuit selectively couples one of the first and the second input stages to the first output stage and selectively couples the other of the first and the second input stages to the second output stage;
wherein, the first switch circuit further selectively provides one of the first and the second input signals to the first input stage and selectively provides the other of the first and the second input signals to the second input stage.
